(19) United States
(12) Patent Application Publication
(10) Pub. No.: US 2003/0044002 A1
(43) Pub. Date: Mar. 6, 2003

(54) Three dimensional audio telephony

(76) Inventors: David M. Yeager, Boca Raton, FL (US); Scott K. Isabelle, Waukegan, IL (US); Karl F. Mueller, Sunrise, FL (US); Sivakumar Muthuswamy, Plantation, FL (US); Xinyu Dou, Fox River Grove, IL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/941,071

(22) Filed: Aug. 28, 2001

(51) Int. Cl. H04M 1/00

(52) U.S. Cl. 379/444

(57) ABSTRACT

A method for creating spatially resolved audio signals for a listener (18) that are representative of one or more callers (12, 14, 16). A digital data signal (13) that represents the individual caller's voice (12) contains an embedded tag (24) that is identifiable with the individual caller. The digital data signal is transmitted from a sending device at the caller's location to a receiving device (30) at the listener's location. At the listener's receiving device, the tag is used to associate each of the digital data signals with a head related transfer functions (32) that are resident in the receiving device by consulting a lookup table. The digital data streams are then convolved (34) with the associated head related transfer function to form binaural digital signals, which are ported to two or more acoustic transducers (36) to create analog audio signals that appear to emanate from different spatial locations around the listener.

### TECHNICAL FIELD

The invention relates generally to the field of three dimensional audio technology and more particularly to the use of head related transfer functions (HRTF) for separating and imposing spatial cues to a plurality of audio signals in order to generate local virtual signals such that each incoming caller is heard at a different location in the virtual auditory space of a listener.

### BACKGROUND

Telephone conference calls are a popular and well known way for three or more individuals located at separate locations to virtually ‘meet’ and discuss business without the need for any of them to travel. Because they save large amounts of travel expenses, conference calls are often used in conjunction with speaker phones in meeting rooms to connect a room full of people with others in remote locations. Listeners typically determine who is currently speaking by the sound of his or her voice, but this can be confusing if there are a large number of speakers or if a listener is not familiar with the speaker, or if the audio quality of the conversation is poor due to shoddy equipment. Some have sought to solve this problem by coupling lights with each remote telephone, so that whenever caller “A” is speaking, a light corresponding to caller “A” is lit at the receiving telephone. However, this does not overcome the problem of many people using a speaker phone in a meeting room. Indeed, callers generally identify themselves at the beginning of their comments with a phrase such as “This is Dave . . . ”, or “This is Scott . . . ” so as to avoid confusion, or a listener is often forced to ask “Who is speaking now? Karl? Siva? or Xinyu?” The cumulative effect of this problem is confusion, wasted time and money, and most such meetings are substantially lengthened by these interjected comments. It would be significant contribution to the art if there were a way for a listener to uniquely identify the various participants in a conference call at all times, and even more desirous if this could be done without the need for any extra effort or conscious thought by the listener.

### BRIEF DESCRIPTION OF THE DRAWINGS

FIG. 1 is a schematic diagram of one embodiment of a method for three dimensional audio telephony in a listener's auditory space in accordance with the invention.

### DETAILED DESCRIPTION OF THE PREFERRED EMBODIMENT

The invention is directed to a method for creating spatially resolved audio signals for a listener that are representative of one or more callers. A digital data signal that represents the individual caller's voice contains an embedded tag that is identifiable with that caller. The digital data signal is transmitted from a sending device at the caller's location to a receiving device at the listener's location. At the listener's receiving device, the tag is used to associate each of the digital data signals with a head related transfer function that is resident in the receiving device by consulting a lookup table. The digital data streams are then convolved with the associated head related transfer function to form a binaural digital signal, which is ported to two or more acoustic transducers to create analog audio signals that appear to emanate from different spatial locations around the listener. Although speech communication using a cellular telephone is described herein for purposes of illustration, it should be noted that our invention is not meant to be limited thereto, but is applicable to other types of communications systems as well, typical examples being two way radio, wire, and optical communications systems.

While the specification concludes with claims defining the features of the invention that are regarded as novel, it is believed that the invention will be better understood from a consideration of the following description in conjunction with the drawing figures, in which like reference numerals are carried forward. Three dimensional (3-D) audio technology is a generic term associated with a number of systems that have recently made the transition from the laboratory to the commercial audio world. Numerous terms have been used both commercially and technically to describe this technique, such as dummy head synthesis, spatial sound processing, etc. All these techniques are related in their desired result of providing a psychoacoustically enhanced auditory display. Three dimensional audio technology utilizes the concept of digital filtering based on head related transfer functions (HRTF). The head and pinnae of the human are naturally shaped to provide a transfer function for received audio signals and thus have a characteristic frequency and phase response for a given angle of incidence of a source to a listener. This characteristic response is convolved with sound that enters the ear and contributes substantially to our ability to listen spatially. Accordingly, this spectral modification imposed by an HRTF on an incoming sound has been established as an important cue for auditory spatial perception, along with interaural level and amplitude differences. The HRTF imposes a unique frequency response for a given sound source position outside of the head, which can be measured by recording the impulse response in or at the entrance of the ear canal and then examining its frequency response via Fourier analysis. This binaural impulse response has been digitally implemented in a 3-D audio system by convolving the input signal in the time domain with the impulse response of two HRTFs, one for each ear, using two finite impulse response filters. This concept is well described in U.S. Pat. No. 5,438,623 “Multi-Channel Spatialization System For Audio Signals”, which is incorporated herein by reference. Although the primary application of 3-D sound has been in the field of entertainment (commercial music recording, playback and playback enhancement techniques) others have utilized the technology in advanced human-machine interfaces such as computer work stations, aeronautics and virtual reality systems. These systems simulate virtual source positions for audio inputs either with speakers, e.g. U.S. Pat. No. 4,856,064 or with headphones connected to magnetic tracking devices, e.g. U.S. Pat. No. 4,774,515 such that the virtual position of the auditory source is independent of head movement.

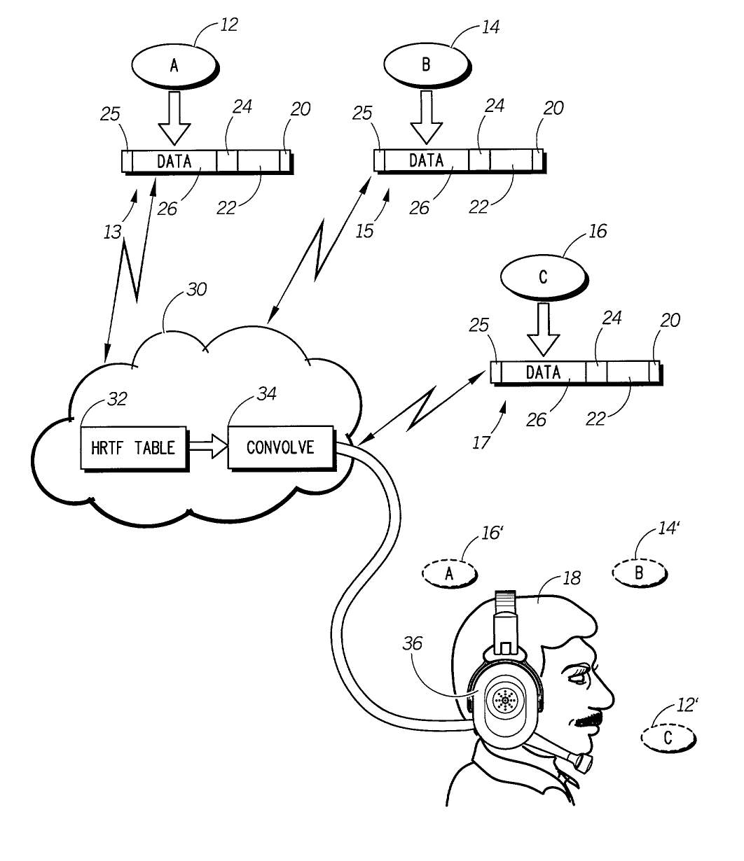

Building upon this prior art, we have incorporated, for example, the use of spatial acoustic imaging using HRTF into cellular telephones. Digital cellular telephones now contain stereo (2 channel) capability in order to support various multimedia features such as MP-3, MPEG4, FM radio broadcasts, Dolby digital 5.1, etc. In order for a user to take full advantage of these features, stereo headphones, stereo ear buds or attachment to stereo speakers such as a home hi-fi or personal computer configuration is required. These two channels and the accompanying headphones can also be used to create acoustic imaging such that virtual acoustic sources are spatialized (placed in virtual 3D acoustic space at specific locations). One example is to use acoustic imaging in a conference call to distinguish individual talkers, which will now be illustrated by example. Referring now to FIG. 1, a schematic diagram of one embodiment of our invention, callers David, Scott, Karl and Siva (12, 14, 16 and 18 respectively) are participating in a conference call, with Siva 12 designated as the ‘listener’. For purposes of this description, each caller is using their own cellular telephone, and each is located away from the others, and although for simplicity of illustration the listener is not depicted in FIG. 1 as sending a data stream, in reality the conversation occurs in a give and take manner (i.e. two-way) with (FULL DUPLEX) transmissions going in both directions. The reader should note that many versions of this scenario can occur, for example, greater or fewer callers, some callers using a ‘land line’ (i.e. conventional wired telephone), some callers in a meeting room using a single speaker phone, all callers having the capability of 3D audio telephony, etc., and they would not depart from the scope and spirit of our invention. In one embodiment using Transmission Control Protocol (TCP)(/)Mobile Internet Protocol (IP), and Point-to-Point Protocol (PPP), a digital data stream or signal 13, 15, 17 is created using well known methods each time one of the callers 12, 14, 16 speaks to initiate a transmission. Another form of transmission that can be used is Cellular Digital Packet (CDPD). CDPD is a two-way switched messaging and data network capability which is an overlay (add-on) capability to existing AMPS/IS-136 cellular networks. In general, the present invention can be embodied with any communication protocol that uses data packets as means of transferring digital information and that includes a source identification information as part of the data packet. Multiple users share a single channel by transmitting short bursts of data at a raw bit rate of 19.2 kilobits per second. It can use multiple ‘idle’ channels. Embedded in these digital data streams 13, 15, 17 are a PPP header 20, the TCP/IP packet 22, a unique tag 24 that identifies the caller, and the data 24 (i.e. the digitized speech of the caller). Each caller's digital data stream contains a unique tag that identifies him. The tag can assume many forms, and those skilled in the art will appreciate that some of the already present data embedded in known data streams contains information that can be utilized as a tag, without the need for adding additional data bits.

Continuing on with our example of a cellular phone conversation, each of the digital data streams is transmitted from the caller's sending device via conventional wireless infrastructure to the listener's receiving device, where the plurality of digital data streams and tags are each associated to head related transfer functions (HRTF) that are resident in the receiving device 30. The HRTF is typically located in a lookup table 32, and, in the preferred embodiment, is user selectable or changeable. The HRTFs are used to aid in imposing spatial cues to the plurality of caller's data streams, and store both head related transfer function impulse response data and source positional information for a plurality of desired virtual source locations. For example, the listener 18 might desire that the voice 12′ of caller 12 be spatially located directly in front of him, while the voice 14′ of caller 14 be spatially located to the left, and the voice 16′ of caller 16 be spatially located to the right. Once the various data streams are associated with the appropriate HRTF, they are convolved 34 to form a binaural digital signal that is conventionally ported or fed to a pair of acoustic transducers, such as headphones, 36 so as to create a three dimensional aural effect to locate the auditory source in the listener's 18 virtual auditory space. These three dimensional audio signals appear to come from separate and discrete positions from about the head of a listener wearing headphones. Further, multiple audio signal streams can be separated into discrete selectively changeable external spatial locations about the head of the listener. The audio signals can be reprogrammed to distribute the signals to different locations about the head of the listener. In order to create the 3D effect, at least two acoustic transducers are required, but a greater number could be employed to give better effect. The acoustic transducers need not be worn by the listener, but could consist of speakers in a chamber or room surrounding the listener. Since the HRTFs are stored in the listener's receiving device (for example, as firmware or software stored in a lookup table in a cellular telephone), the listener also has the capability of selecting the particular spatial location that each caller is to appear in. For example, the listener might desire that whenever caller Dave is speaking, his voice will always appear to be coming from the listener's right front. Or, in other situations, the listener might want to change the spatial location of caller Dave.

Another embodiment of the present invention is a system for simulating the spatial distribution of speech sources in a conference room where multiple people are participating in a conference call with a remote listeners device. In this embodiment, a single conference style telephone device with multiple microphones is used to transmit the voice data of all the people in the conference room. The conference style microphone generates the unique tag that identifies the primary speaker by resolving the sound level inputs into the microphone. The microphone system in the conference style telephone identifies the person who is currently speaking by the pattern of acoustic waves incident on the microphone system and relative location of each of the three people in the conference room. This information is used to tag the packets in the digital stream that is sent to remote users. The 3D telephony device at the remote location enables the listener at the remote location to distribute audio signals from multiple users in the conference room into separated discrete selectively changeable external spatial locations about the head of the listener. The listener in this fashion gets a simulated spatial distribution of audio signals from multiple speakers in a conference room. Although the microphone system has been used as the means for identifying particular speakers in the conference room, many other methods such as speaker recognition systems can be used instead to identify the speaker and generate the speaker's unique tag for the digital packet without deviating from the spirit of the present invention.

In summary, we have created a method for producing three dimensional audio telephony using synthetic head related transfer functions to impose spatial cues to a plurality of audio inputs in order to generate virtual sources thereof. This is achieved in part by generating synthetic head related transfer functions for imposing reprogrammable spatial cues to a plurality of digital signals, convolving the signals and the HRTF to create source positional information for a plurality of desired virtual source locations. The outputs are subsequently fed to headphones. While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. For example, the techniques of the present invention can be used to improve the realism of gaming applications.

What is claimed is:

1. A method for three dimensional audio telephony in a listener's virtual auditory space, comprising:
creating a digital data stream representative of an auditory source, said digital data stream having a tag identifiable to said auditory source;
transmitting said digital data stream from a sending device to a listener's receiving device;
at the receiving device, said digital data stream and tag associated to a head related transfer function that is resident in the receiving device;
convolving the digital data stream with the associated head related transfer function to form a binaural digital signal;
porting said binaural digital signal to at least two acoustic transducers so as to create a three dimensional aural effect to locate the auditory source in the listener's virtual auditory space.

2. The method for three dimensional audio telephony in a listener's virtual auditory space as described in claim 1, wherein the location of the auditory source in the listener's virtual auditory space is selectively changeable by the listener.

3. The method for three dimensional audio telephony in a listener's virtual auditory space as described in claim 1, wherein said at least two acoustic transducers comprise headphones wearable by the listener.

4. The method for three dimensional audio telephony in a listener's virtual auditory space as described in claim 1, wherein the head related transfer functions that are resident in the receiving device are stored in a lookup table.

5. The method for three dimensional audio telephony in a listener's virtual auditory space as described in claim 1, wherein the auditory source is a human voice.

6. The method for three dimensional audio telephony in a listener's virtual auditory space as described in claim 1, wherein the auditory source is an alert tone.

7. A method for three dimensional audio telephony in a listener's auditory space, comprising:
creating a plurality of digital data streams, each representative of one of a plurality of callers, each of said digital data streams having a unique tag identifiable to said caller;
transmitting said digital data streams from at least one sending device to at least one listener receiving device;
at the receiving device, each of said digital data streams associated to a head related transfer function that is resident in the receiving device;
convolving each of said digital data streams with the associated head related transfer function to form a plurality of binaural digital signals;
porting said plurality of binaural digital signals to at least two acoustic transducers in the listener's auditory space so as to create a three dimensional aural effect to virtually locate the plurality of callers in the listener's auditory space.

8. The method for three dimensional audio telephony in a listener's auditory space as described in claim 7, wherein said at least two acoustic transducers comprise headphones wearable by the listener.

9. The method for three dimensional audio telephony in a listener's auditory space as described in claim 7, wherein the sending device comprises a cellular telephone.

10. The method for three dimensional audio telephony in a listener's auditory space as described in claim 7, wherein the receiving device comprises a cellular telephone.

11. The method for three dimensional audio telephony in a listener's auditory space as described in claim 7, wherein the head related transfer functions that are resident in the receiving device are stored in a lookup table.

12. The method for three dimensional audio telephony in a listener's auditory space as described in claim 7, wherein the location of the callers in the listener's auditory space is selectively changeable by the listener.

13. A method for creating spatially resolved audio signals for a listener that are representative of a plurality of callers, comprising:
creating a plurality of digital data streams, each digital data stream representative of an individual caller's voice, and each digital data stream having a tag identifiable to said individual caller's voice;
transmitting said plurality of digital data streams from a sending device at the caller's location to a receiving device at the listener's location;
at the receiving device, associating the tag in each of said plurality of digital data streams with a head related transfer function that is resident in the receiving device;
convolving each of said plurality of digital data streams with the associated head related transfer function to form a plurality of binaural digital signals;
coupling said plurality of binaural digital signals to at least two acoustic transducers so as to create a plurality of analog audio output signals which appear to emanate from different spatial locations around the listener.

14. The method for creating spatially resolved audio signals for a listener as described in claim 13, wherein the spatial locations that said plurality of analog audio output signals appear to emanate from are selectively changeable by the listener.

15. The method for creating spatially resolved audio signals for a listener as described in claim 13, wherein said at least two acoustic transducers comprise headphones wearable by the listener.

16. The method for creating spatially resolved audio signals for a listener as described in claim 13, wherein the sending device comprises a cellular telephone.

17. The method for creating spatially resolved audio signals for a listener as described in claim 13, wherein the receiving device comprises a cellular telephone.

18. The method for creating spatially resolved audio signals for a listener as described in claim 13, wherein the head related transfer functions that are resident in the receiving device are stored in a lookup table.
